(19) United States
(12) Patent Application Publication
(10) Pub. No.: US 2024/0165924 A1
(43) Pub. Date: May 23, 2024

(54) PANELS AND METHOD FOR PRODUCING PANELS

(71) Applicant: FLOORING INDUSTRIES LIMITED, SARL, Bertrange (LU)

(72) Inventors: Benjamin CLEMENT, Waregem (BE); Sam LEDEGEN, Gent (BE); Thomas DERUYTER, Zulte (BE); Leen DE LANGE, Ledeberg (BE)

(21) Appl. No.: 18/283,068

(22) PCT Filed: Mar. 3, 2022
(86) PCT No.: PCT/IB2022/051876

§ 371 Date: Sep. 20, 2023

(30) Foreign Application Priority Data
Mar. 24, 2021 (BE) 2021/5221

(51) Int. Cl. B32B 21/06; B32B 7/12; B32B 21/02; B32B 38/06

(52) U.S. Cl. CPC B32B 21/06; B32B 7/12; B32B 21/02; B32B 38/06; B32B 2250/02; B32B 2260/028; B32B 2260/046; B32B 2305/07; B32B 2607/00

(57) ABSTRACT

Panels include a decorative paper layer impregnated with a resin, and a substrate. The decorative paper layer is incorporated in the panel by means of polyurethane.

The present invention relates to panels in which a decorative paper is bonded to the panel substrate in a more reliable manner. This decorative paper may have a uniform colour or may be provided with a decorative print. The invention furthermore relates to methods for producing such panels.

Panels comprising a substrate and a decor are generally known, for example in the form of MDF (Medium Density Fibreboard) or HDF (High Density Fibreboard) panels, such as for example the laminate panels described in WO97/47834, in the form of vinyl panels, such as for example in WO2013/026559, or in the form of so-called (Wood Plastic Composite) panels with a vinyl top layer, such as for example described in WO2014/065953.

The laminate panel of WO97/47834 comprises an MDF or HDF substrate to which a decor layer is applied. This decor layer comprises a printed paper impregnated with melamine formaldehyde resin. The laminate panel is produced by pressing the decor layer onto the MDF or HDF substrate at elevated temperature and under pressure, in which case the melamine formaldehyde resin cures by means of a polycondensation reaction and consequently ensures the bond between decorative paper layer and the substrate. This polycondensation reaction causes water to form which may be absorbed by the MDF or HDF substrate. Usually, a wear layer is laminated onto the printed paper layer—during the same pressing process. This wear layer is a melamine formaldehyde-impregnated paper which optionally comprises wear-resistant particles, such as for example aluminium oxide particles. During the pressing operation, a texture may be pressed into the surface of the panel by using a textured press plate.

The waterproof panels from WO2013/026559 have a substrate made of PVC (polyvinyl chloride) with a printed decor layer made of PVC and a wear layer made of PVC. Such panels have surface properties which are inferior to those of the panels described in WO97/47834.

WO2011/003763A2 mentions the production of so-called Compact Board. This is a panel which comprises a substrate composed of a number of layers of phenol formaldehyde-impregnated paper and a decorative top layer which comprises a melamine formaldehyde resin-impregnated decorative paper layer. The various layers are pressed together at elevated temperature and under pressure, in which case the phenol formaldehyde and the melamine formaldehyde crosslink, resulting in a bond between the various layers. It is a drawback of this technology that all layers have to be pressed together. When pressing the phenol formaldehyde-impregnated paper layers first and only pressing the decorative paper layer onto the already compressed phenol formaldehyde layers, the bond is problematic. It is nevertheless attractive to follow such an approach, since this makes it possible to produce base panels in large numbers and inexpensively, and to only add a decor layer by pressing later, if desired.

WO2006/082509A2 relates to a sandwich panel made of three layers: a first outer layer, a middle layer and a second outer layer. The middle layer is a thick, strong panel formed by pressing various layers of paper impregnated with phenol formaldehyde resin together at elevated temperature. The first and the second outer layers are thin, strong panels formed of different layers of impregnated paper and formed by compression at elevated temperature. The sandwich panel is produced by applying a layer of adhesive to the surfaces of the middle layer or to the inner surfaces of the first and the second outer layer. Subsequently, the various layers are pressed together. However, the application of the layer of adhesive to these strong outer layers or to the middle layer is an additional complicated step.

U.S. Pat. No. 9,611,659B2 describes a panel which comprises a waterproof PVC panel and a melamine resin layer which is bonded to the waterproof PVC panel by means of a bonding layer. U.S. Pat. No. 9,611,659B2 furthermore describes a method for producing such panels in which a hard, crosslinked melamine sheet is glued onto the PVC panel. It is a drawback of the method from U.S. Pat. No. 9,611,659B2 that delamination of the adhesively bonded layers may occur if the adhesive is not sufficiently resistant. In addition, large quantities of adhesive are required to glue the melamine resin layer onto the panel, as a result of which the thickness of the panel and the costs thereof increase.

U.S. Pat. No. 8,956,714B2 mentions a waterproof panel and a method for producing a waterproof vinyl panel. The top of the melted PVC is provided with a glass fleece or a paper layer. A melamine layer may be applied on top thereof at elevated temperature and under pressure.

WO2020/194202A1 describes a panel which comprises a substrate and a top layer. The top layer comprises at least a melamine resin and a binder. The binder is selected from the group comprising polyacrylate-based binders, polyvinyl acetate-based binders, polyester-based binders, acryl copolymer-based binders or urethane-based binders.

DE102019203755A1 describes a process for producing a panel. The method comprises the following steps: (A) a carrier web is coated with a liquid polymerizable coating, (B) drying the coated carrier web, the polymerizable coating not being crosslinked, or only partly, (C) producing a multi-layered structure which comprises at least a coated carrier web and at least one core layer, and pressing this multi-layered structure in order to completely crosslink the polymerizable coating. Optionally, bonding layers are added between the carrier web and the substrate, in which case the bonding layer may be made of a paper impregnated with a thermosetting resin. It is a drawback of such an approach that the bond between the various layers is not always optimal.

EP3587108A1 describes a panel made of wood. This panel comprises a central layer made of particleboard and a wood fibre layer or laminate layer as outer layer. A paper impregnated with synthetic resin is arranged between the central layer and the outer layer. A layer of adhesive is provided between the paper impregnated with synthetic resin and the outer layer, which layer may be, for example, a hot-melt adhesive, a polyurethane adhesive or an ethylene vinyl acetate adhesive.

It is an object of the invention to provide panels with an excellent bond between the various layers in the panel. It is furthermore an object of at least some embodiments of the invention to optimize the production of panels by using polyurethane as a bonding layer.

Polycondensation moisture formed during crosslinking of melamine formaldehyde resin when laminating various layers may result in problems with regard to the bond of the various layers. In the various aspects of the invention, polyurethane has been used in all cases to ensure an improved bond between the various layers of the produced panel. The problems mentioned are solved by the various aspects of the invention, resulting in an improved bond between the various layers.

The first aspect of the invention relates to a sheet, the sheet comprising a paper layer, characterized by the fact that the paper layer is impregnated with polyurethane, wherein the polyurethane can be crosslinked at elevated temperature.

Such sheets may be used in other aspects of the invention as a bonding layer in panels. The paper layer in the sheet provides a carrier for the polyurethane in the sheet.

A preferred embodiment of the first aspect of the invention is characterized by the fact that the paper layer has a dry weight without the polyurethane of between 10 and 50 grams per square metre, for example 25 grams per square metre. Such an embodiment ensures that a sheet with optimum properties is obtained. The paper effectively acts as a carrier, while it is sufficiently open to cause the sheet to bond on both sides of the sheet during a laminating process and there is no danger of this sheet separating after use thereof as a bonding layer in a laminating process.

A preferred embodiment of the first aspect of the invention is characterized by the fact that the paper layer is an alpha-cellulose paper with an ash content of less than 5% by weight. Such an embodiment ensures that a sheet with optimum properties is achieved. The paper effectively acts as a carrier, while it is sufficiently open to cause the sheet to bond on both sides of the sheet during a laminating process and there is no danger of this sheet separating after use thereof as a bonding layer in a laminating process.

A preferred embodiment of the first aspect of the invention is characterized by the fact that the paper layer is impregnated with between 20 and 60 grams per square metre of dry weight polyurethane. Such an embodiment provides good results when using the sheet in a laminating process, and excellent bonding.

A preferred embodiment of the first aspect of the invention is characterized by the fact that the polyurethane is applied to the paper sheet via a water-based dispersion.

A preferred embodiment of the first aspect of the invention is characterized by the fact that the polyurethane is anionically stabilized. Such embodiments provide good stability of the sheet, so that it can be stored for some time before being used in a laminating process.

A preferred embodiment of the first aspect of the invention is characterized by the fact that the polyurethane is self-crosslinking.

A preferred embodiment of the first aspect of the invention is characterized by the fact that the minimum film forming temperature (MFFT) of the polyurethane is between 0 and 50° C., preferably between 8 and 35° C. This embodiment ensures good processability of the sheet in a laminating process.

A preferred embodiment of the first aspect of the invention is characterized by the fact that the polyurethane is at least partly carboxyl-stabilized. Such embodiments provide good stability of the polyurethane dispersion used.

A preferred embodiment of the first aspect of the invention is characterized by the fact that, after complete curing, the polyurethane has a König hardness according to ISO 1522:2006 of between 50 and 150 seconds. It has been found that these sheets achieve good properties when using these sheets as adhesion layer during laminating.

A preferred embodiment of the first aspect of the invention is characterized by the fact that the polyurethane contains crosslinkers, for example one or more of an isocyanate, a carbodiimide, aziridine, or melamine. When using such sheets as adhesion layer in a laminating process, it is an advantage if the resulting laminated product has an improved resistance to water.

A preferred embodiment of the first aspect of the invention is characterized by the fact that the polyurethane contains silane. Use of such sheets in laminating processes results in laminates which have improved hydrophobicity.

A preferred embodiment of the first aspect of the invention is characterized by the fact that the paper layer is saturated with the polyurethane. This results in optimalization of laminating processes in which the sheet is used and optimization of the properties of the laminate, for example optimum bonding by means of the sheet.

The second aspect of the invention relates to a panel, in which the panel comprises a substrate and a top layer which contains a decorative paper layer, in which the decorative paper layer is impregnated with melamine formaldehyde resin, characterized by the fact that the top layer is bonded to the substrate by means of a sheet as in any embodiment of the first aspect of the invention by crosslinking the polyurethane of the sheet. The decorative paper layer may be of a uniform colour or may have a decorative print.

In certain laminating processes in which a top layer has to be laminated onto a substrate, polycondensation moisture of the melamine formaldehyde resin of the decorative top layer may have negative consequences during the laminating process, for example formation of bubbles if this condensation moisture cannot be absorbed or discharged. During the production of panels according to the second aspect of the invention, this problem does not occur, since the sheet provides the bond between top layer and substrate.

An example of a panel according to the second aspect of the invention is a panel in which the substrate is or comprises a compact board, in which the top layer is laminated onto a compact board which has already been produced. The use of a sheet as in the first aspect of the invention prevents problems with polycondensation moisture caused by the polycondensation reaction of melamine formaldehyde resin of the decorative paper. A compact board is a board which comprises a plurality of paper sheets impregnated with phenol formaldehyde resin which have been compressed to form a board under pressure and at elevated temperature.

A preferred embodiment of the second aspect of the invention is characterized by the fact that the panel comprises a backing layer on the side opposite the side which comprises the top layer, in which the backing layer is or contains a melamine formaldehyde resin-impregnated paper layer which is bonded to the substrate by means of a sheet as in any embodiment of the first aspect of the invention, in which the crosslinking of the polyurethane of this sheet provides the bond between the backing layer and the substrate. Again, adhesion problems between backing layer and substrate due to polycondensation moisture of the melamine formaldehyde resin from the backing layer are prevented.

A preferred embodiment of the second aspect of the invention is characterized by the fact that, on the side facing the substrate, the top layer of the panel comprises a layer of paper impregnated with resin. Preferably, this layer of resin-impregnated paper is impregnated with phenol formaldehyde resin.

Panels according to the second aspect of the invention may be provided with a relief in the decorative surface by using a textured pressure face during the laminating process. The use of such a layer of paper impregnated with resin offers the possibility of pressing a deeper relief into the decorative surface of the panel. This layer of paper also makes it possible to deal with problems with polycondensation moisture from crosslinking the melamine formaldehyde resin even better, as a result of which the bond of the various layers is improved further.

A preferred embodiment of the second aspect of the invention is characterized by the fact that the layer of paper impregnated with resin is in direct contact with the decorative paper layer.

A preferred embodiment of the second aspect of the invention is characterized by the fact that the substrate at least comprises or consists of one of the following:
(i) a compact board which is a board which consists of sheets of paper which have been pressed together at elevated temperature and which have been impregnated with a phenol formaldehyde resin. The term phenol formaldehyde resin also covers resins which contain other ingredients in addition to phenol and formaldehyde, such as melamine.
(ii) a mineral panel, for example a plasterboard or a magnesium oxide panel,
(iii) a vinyl panel which contains fillers—for example mineral fillers or wood-based fillers—, or
(iv) a panel which comprises wood fibres or wood chips which are bonded together by means of a thermosetting binder—for example urea formaldehyde resin or methylene diphenyl diisocyanate resin—, or by means of a thermoplastic binder—for example thermoplastic PVB (polyvinyl butyral)—and/or by means of an elastomer binder—for example elastomer PVB (polyvinyl butyral),
(v) a polyurethane panel or a polyisocyanurate panel.

A preferred embodiment of the second aspect of the invention is characterized by the fact that the top layer comprises a wear layer on top of the decorative paper layer, in which the wear layer comprises a melamine formaldehyde resin-impregnated paper layer which optionally comprises particles which increase the resistance to wear, for example aluminium oxide particles.

Here, the use of the sheet which provides the bond is of even greater importance, because the laminating process also releases polycondensation moisture during crosslinking of the melamine formaldehyde resin in the wear layer.

A preferred embodiment of the second aspect of the invention is characterized by the fact that, on the side facing the top layer, the substrate comprises an additional layer, in which the additional layer is bound into the substrate by means of a sheet such as in any embodiment of the first aspect of the invention. An example of such an additional layer is an aluminium foil to make the panel fire retardant.

The use of the sheet again provides a good bond for the various layers in the panel.

A preferred embodiment of the second aspect of the invention is characterized by the fact that the decorative surface of the panel comprises a relief, preferably in which this relief has been pressed into the decorative surface. This relief may be pressed into the surface of the panel during the pressing operation under pressure and at elevated temperature, in which the top layer is laminated onto the substrate by means of the sheet. In this process, the polyurethane in the sheet is crosslinked, and the melamine formaldehyde resin of the decor layer and of the wear layer, if present, is also crosslinked. When using a textured pressure element in this pressing operation, a relief is pressed into the surface of the panel.

The third aspect of the invention relates to a panel, in which the panel comprises a substrate and a top layer which comprises a decorative paper layer impregnated with melamine formaldehyde resin, characterized by the fact that the top layer is bonded to the substrate by means of a polyurethane bonding layer; preferably in which the polyurethane bonding layer does not contain a carrier or a reinforcing layer. The decorative paper layer may have a uniform colour or may have a decorative print.

In certain laminating processes in which a top layer is to be laminated onto a substrate, polycondensation moisture of the melamine formaldehyde resin of the decorative top layer may have negative consequences during the laminating process, for example the formation of bubbles, if this condensation moisture is not absorbed or cannot be discharged. This problem does not occur during the production of panels according to the third aspect of the invention, since the polyurethane provides the bond between top layer and substrate.

An example of a panel according to the third aspect of the invention is a panel in which the substrate is or comprises a compact board, in which the top layer is laminated onto a compact board which has been already produced. The use of polyurethane as a bonding layer prevents problems with polycondensation moisture produced during the polycondensation reaction of melamine formaldehyde resin of the decor paper.

A preferred embodiment of the third aspect of the invention is characterized by the fact that, on the side facing the substrate, the top layer of the panel comprises a layer of paper impregnated with resin. Preferably, the layer of paper impregnated with resin is impregnated with phenol formaldehyde resin.

Preferably, the layer of paper is impregnated with resin which is in direct contact with the decorative paper layer.

Panels according to the third aspect of the invention may be provided with a relief in the decorative surface by using a textured pressure face during the laminating process. The use of such a layer of paper impregnated with resin offers the possibility to press a deeper relief into the decorative surface of the panel. This layer of paper also makes it possible to deal with problems involving polycondensation moisture of the crosslinking of the melamine formaldehyde resin even better, as a result of which the bond of the various layers is improved further.

A preferred embodiment of the third aspect of the invention is characterized by the fact that the panel, on the side opposite the side which contains the top layer, comprises a backing layer, in which the backing layer is or contains a melamine formaldehyde resin-impregnated paper layer, in which the backing layer is bonded to the substrate by means of a polyurethane bonding layer; preferably in which the polyurethane bonding layer does not contain a carrier or a reinforcing layer. Again, this prevents adhesion problems between backing layer and substrate resulting from polycondensation moisture of the melamine formaldehyde resin of the backing layer.

A preferred embodiment of the third aspect of the invention is characterized by the fact that the substrate at least comprises one of the following:
(i) a compact board which is a board which consists of sheets of paper which have been pressed together at elevated temperature and which have been impregnated with a phenol formaldehyde resin. The term phenol formaldehyde resin also covers resins which contain other ingredients in addition to phenol and formaldehyde, such as melamine.
(ii) a mineral panel, for example a plasterboard or a magnesium oxide panel,
(iii) a vinyl panel which contains fillers—for example mineral fillers or wood-based fillers—, or
(iv) a panel which comprises wood fibres or wood chips which are bonded together by means of a thermosetting binder—for example urea formaldehyde resin or methylene diphenyl diisocyanate resin—, or by means of a thermoplastic binder—for example thermoplastic PVB (polyvinyl butyral)—and/or by means of an elastomer binder—for example elastomer PVB (polyvinyl butyral),
(v) a polyurethane panel or a polyisocyanurate panel.

A preferred embodiment of the third aspect of the invention is characterized by the fact that the top layer comprises a wear layer on top of the decorative paper layer, in which the wear layer comprises a melamine formaldehyde resin-impregnated paper layer which optionally comprises particles which increase the resistance to wear, for example aluminium oxide particles.

Here, the use of the polyurethane bonding layer is of even greater importance, because the laminating process also releases polycondensation moisture during crosslinking of the melamine formaldehyde resin in the wear layer.

A preferred embodiment of the third aspect of the invention is characterized by the fact that, on the side facing the top layer, the substrate contains an additional layer, in which the additional layer is bound into the substrate by means of a polyurethane bonding layer; preferably in which the polyurethane bonding layer does not contain a carrier or a reinforcing layer. An example of such an additional layer is an aluminium foil to make the panel fire-retardant.

The use of the polyurethane bonding layer again ensures a good bond between the various layers in the panel.

A preferred embodiment of the third aspect of the invention is characterized by the fact that the decorative surface of the panel comprises a relief, preferably in which this relief has been pressed into the decorative surface. This relief may be pressed into the surface of the panel during the pressing operation under pressure and at elevated temperature, with the top layer being laminated onto the substrate by means of the polyurethane bonding layer. In this process, the polyurethane in the polyurethane bonding layer is crosslinked, and crosslinking also occurs in the melamine formaldehyde resin of the decor layer and of the wear layer, if the latter is present. When a textured pressure element is used in this pressing operation, a relief is pressed into in the surface of the panel.

The fourth aspect of the invention relates to a method for producing a panel such as in any embodiment of the second aspect of the invention, in which the method comprises the following steps:
supplying a substrate,
supplying a top layer which contains a decorative paper layer which has been impregnated with melamine formaldehyde resin;
supplying a sheet such as in any embodiment of the first aspect of the invention and arranging this sheet between the substrate and the top layer;
pressing together the top layer, the sheet and the substrate at elevated temperature and under pressure, during which crosslinking of the melamine formaldehyde resin occurs and in which the crosslinking of the polyurethane of the sheet provides the bond between the top layer and the substrate.

The decorative paper layer may be uniform in colour or may be provided with a decorative print.

This method results in a high-quality panel in which the various layers of the panel have been bonded to each other in a satisfactory manner.

A preferred embodiment of the fourth aspect of the invention is characterized by the fact that the temperature during pressing is between 140 and 220 degrees, more preferably is between 160 and 220 degrees, and even more preferably this temperature is between 180 and 220 degrees. These conditions produce optimum results in the pressing process.

A preferred embodiment of the fourth aspect of the invention is characterized by the fact that the duration of the pressing operation is between 10 to 120 seconds, preferably between 10 to 60 seconds, even more preferably between 12 and 22 seconds. These conditions produce optimum results in the pressing process.

The fifth aspect of the invention relates to a method for producing a panel as in any embodiment of the third aspect of the invention, in which the method comprises the following steps:
supplying a substrate,
supplying a decorative paper layer impregnated with melamine formaldehyde resin;
supplying, between the substrate and the decorative paper layer, a layer of paper impregnated with resin, preferably impregnated with phenol formaldehyde resin; in which the side of this layer of paper facing the substrate contains a polyurethane coating,
pressing together the substrate, the layer of paper impregnated with resin and the decorative paper layer at elevated temperature and under pressure, during which crosslinking of the melamine formaldehyde resin and of the polyurethane of the polyurethane coating occurs, so that the substrate, the layer of paper impregnated with resin and the decorative paper layer are laminated to each other.

The decorative paper layer may have a uniform colour or may be provided with a decorative print.

This method produces a high-quality panel in which the various layers of the panel have been bonded to each other in a satisfactory manner.

A preferred embodiment of the fifth aspect of the invention is characterized by the fact that the temperature during pressing is between 140 and 220 degrees, more preferably is between 160 and 220 degrees, and even more preferably is between 180 and 220 degrees. These conditions produce optimum results in the pressing process.

A preferred embodiment of the fifth aspect of the invention is characterized by the fact that the duration of the pressing operation is 10 to 120 seconds, preferably 10 to 60 seconds, even more preferably between 12 and 22 seconds. These conditions produce optimum results in the pressing process.

The sixth aspect of the invention relates to a panel, in which the panel comprises a substrate and a top layer bonded to the substrate, in which the top layer contains a decorative paper, in which this decorative paper is impregnated with melamine formaldehyde resin or with acrylate resin, in which this decorative paper, on the side bonded to the substrate, comprises a polyurethane bonding layer which provides the bond between the decorative paper and the substrate.

The various layers in the panel are bonded to each other in a satisfactory manner. There is no risk of local or complete delamination. Possible problems with polycondensation moisture during crosslinking of melamine formaldehyde resin are prevented. An example of such problems is the occurrence of bubbles. The polyurethane provides a good bond between the top layer and the substrate, while the resin with which the decorative paper was impregnated ensures that separation of the decorative paper layer is prevented. Impregnating the decorative paper only with polyurethane, which would then have to provide the required adhesion, has been found not to be sufficient to prevent separation of the paper. Thus, both impregnation of the decorative paper with resin—melamine formaldehyde resin or acrylate resin—and a polyurethane adhesion layer are required to produce a high-quality panel. The polyurethane may be applied by means of a coating on the melamine formaldehyde resin-impregnated or acrylate resin-impregnated decorative paper, after which the top layer may be pressed onto the substrate under elevated pressure and at elevated temperature, during which crosslinking of the resin and of the polyurethane occurs.

A preferred embodiment of the sixth aspect of the invention is characterized by the fact that the polyurethane bonding layer contains 7 to 15 grams per square metre of dry weight polyurethane. Such embodiments produce excellent results with regard to the quality of the panel.

A preferred embodiment of the sixth aspect of the invention is characterized by the fact that the decorative paper, by means of the polyurethane bonding layer, is bonded to a layer of the substrate which contains polyvinyl butyral as a binder and filler. This filler may be a wood-based filler, for example wood chips and/or wood fibres and/or wood dust. More preferably, the substrate also comprises a layer made of MDF (Medium Density Fibreboard) or HDF (High Density Fibreboard). An example of such a substrate comprises an MDF or HDF board, on which a layer is arranged which comprises wood-based filler which is bonded together by means of thermoplastic or elastomer polyvinyl butyral (PVB).

Due to their melamine formaldehyde resin, melamine formaldehyde-impregnated decor layers adhere well to MDF or HDF panels. However, it has been found that they do not adhere well to layers which contain wood-based filler and have been bonded to each other by means of thermoplastic or elastomer polyvinyl butyral (PVB). By contrast, the use of the polyurethane bonding layer as in this embodiment of the invention ensures a good bond and a high-quality panel.

A preferred embodiment of the sixth aspect of the invention is characterized by the fact that the polyurethane is anionically stabilized. Such embodiments provide a good stability of the sheet, so that it can be stored for some time before being used in a laminating process.

A preferred embodiment of the sixth aspect of the invention is characterized by the fact that the polyurethane is self-crosslinking.

A preferred embodiment of the sixth aspect of the invention is characterized by the fact that the minimum film forming temperature (MFFT) of the polyurethane is between 5 and 50° C., preferably between 8 and 35° C. This embodiment provides good processability during the pressing operation in which the panel is produced by laminating the various layers to each other.

A preferred embodiment of the sixth aspect of the invention is characterized by the fact that, after complete curing, the polyurethane has a König hardness according to ISO 1522:2006 of between 50 and 150 seconds. It has been found that using such a polyurethane results in good properties for use as bonding layer in the invention.

A preferred embodiment of the sixth aspect of the invention is characterized by the fact that the polyurethane is at least partly carboxyl-stabilized.

A preferred embodiment of the sixth aspect of the invention is characterized by the fact that the substrate comprises wood fibres and/or wood chips, preferably in which the wood fibres and/or the wood chips are glued together by means of a thermosetting adhesive or by means of a thermoplastic.

A preferred embodiment of the sixth aspect of the invention is characterized by the fact that the decorative surface of the panel comprises a relief, preferably in which this relief has been pressed into the decorative surface.

This relief may be pressed into the surface of the panel during the pressing operation under pressure and at elevated temperature, with the top layer being laminated onto the substrate by means of the polyurethane bonding layer.

The seventh aspect of the invention relates to a panel, optionally a panel as in any embodiment of the sixth aspect of the invention, in which the panel comprises a substrate and a top layer bonded to the substrate, in which the top layer comprises a decorative paper, in which this decorative paper is impregnated with melamine formaldehyde resin or with acrylate resin, in which the top layer comprises a lacquer layer on the other side of the side bonded to the substrate, in which the lacquer layer optionally contains particles in order to increase the resistance to wear, characterized by the fact that the panel comprises a polyurethane bonding layer which provides the bond between the decorative paper and the lacquer layer.

The polyurethane bonding layer provides a good bond between the lacquer layer and the impregnated decorative paper. When a bond by means of polyurethane is used, it might seem superfluous to impregnate the decorative paper with melamine formaldehyde resin or with acrylate resin. However, it has been found that when this impregnation is absent, the polyurethane does provide adhesion with the lacquer layer, but that there is a risk of the decorative paper separating. The inventors suspect that this is caused by insufficient saturation of the decorative paper with the polyurethane, even if the polyurethane has been applied to the decorative paper or the paper has been immersed in a bath. Therefore, the decorative paper is first impregnated with resin—either melamine formaldehyde resin or acrylate resin—and a polyurethane bonding layer is then applied in addition.

Examples of lacquer layers which may be used in this case are acrylate lacquer layers, polyurethane acrylate lacquer layers, polyurethane lacquer layers or thermosetting polyester lacquer layers.

Preferably, the lacquer layer is bonded directly to the impregnated decorative paper by means of the polyurethane adhesion layer.

A preferred embodiment of the seventh aspect of the invention is characterized by the fact that the polyurethane bonding layer which provides the bond between the decorative paper and the lacquer layer contains 7 to 15 grams per square metre of dry weight polyurethane. Such embodiments produce excellent results with regard to the quality of the panel.

A preferred embodiment of the seventh aspect of the invention is characterized by the fact that the polyurethane of the polyurethane bonding layer which provides the bond between the decorative paper and the lacquer layer is anionically stabilized.

A preferred embodiment of the seventh aspect of the invention is characterized by the fact that the polyurethane of the polyurethane bonding layer which provides the bond between the decorative paper and the lacquer layer is self-crosslinking.

A preferred embodiment of the seventh aspect of the invention is characterized by the fact that the minimum film forming temperature (MFFT) of the polyurethane of the polyurethane bonding layer which provides the bond between the decorative paper and the lacquer layer is between 5 and 50° C., preferably between 8 and 35° C.

A preferred embodiment of the seventh aspect of the invention is characterized by the fact that the polyurethane of the polyurethane bonding layer which provides the bond between the decorative paper and the lacquer layer is at least partly carboxyl-stabilized.

A preferred embodiment of the seventh aspect of the invention is characterized by the fact that the substrate contains wood fibres and/or wood chips, preferably in which the wood fibres and/or the wood chips are glued together by means of a thermosetting adhesive or by means of a thermoplastic.

A preferred embodiment of the seventh aspect of the invention is characterized by the fact that the decorative surface of the panel comprises a relief, preferably in which this relief has been pressed into the decorative surface.

This relief may be pressed into the surface of the panel under pressure and at elevated temperature during the pressing operation in which the top layer is laminated onto the substrate by means of the polyurethane bonding layer.

A preferred embodiment of the sixth aspect and/or of the seventh aspect of the invention in which the decorative paper is impregnated with melamine formaldehyde resin is characterized by the fact that the melamine formaldehyde resin contains at least 25% by weight of modifier with respect to the total amount of melamine formaldehyde resin. This percentage by weight has been determined with respect to the amount of dry matter. It is an advantage of such embodiments that the production of a high-quality panel is facilitated, because it is easier to coat decorative paper impregnated with such a melamine formaldehyde resin on one side or on both sides with polyurethane; polyurethane which will then form the bonding layer or bonding layers. The inventors suspect that this is caused by the fact that the higher amount of modifier produces a more flexible melamine formaldehyde resin-impregnated decorative paper.

More preferably, the melamine formaldehyde resin contains at least 30% by weight of modifier with respect to the total amount of melamine formaldehyde resin. Even more preferably, the melamine formaldehyde resin contains at least 35% by weight of modifier with respect to the total amount of melamine formaldehyde resin. Even more preferably, the melamine formaldehyde resin contains at least 40% by weight of modifier with respect to the total amount of melamine formaldehyde resin. These percentages by weight have been determined with respect to the amount of dry matter.

Modifiers which may be used in this case are for example glycerol, poly-alcohols, polyglycols, polyvinyl alcohol, phenoxyethanol, phenyl glycol, saccharides, dimethyl formamides, caprolactam, guanamines, toluene sulphonamide, dicyandiamide, and urea.

In order to show the features of the invention in more detail, some preferred embodiments are described below by way of example and without being limited thereto, with reference to the accompanying drawings, in which:

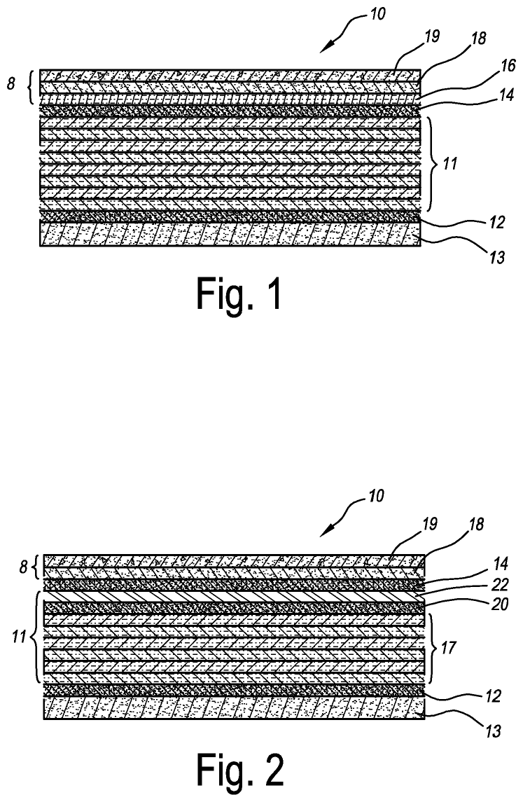

FIG. 1 illustrates a panel according to the second aspect of the invention;

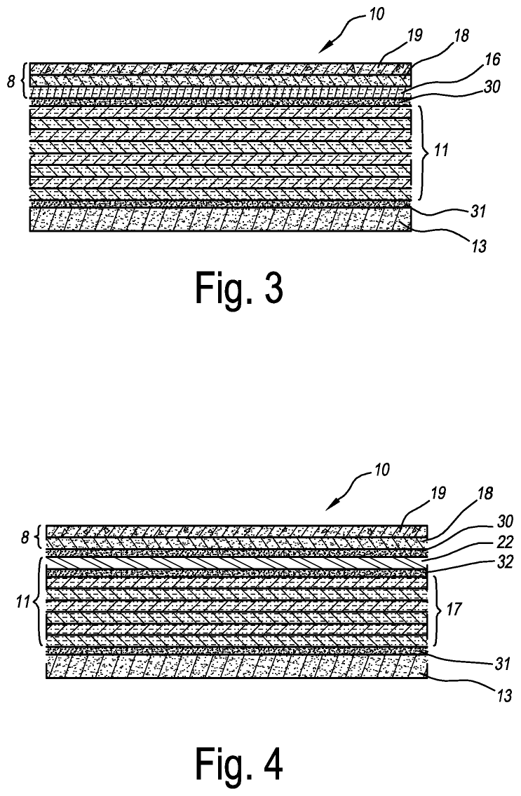

FIG. 2 illustrates a panel according to the second aspect of the invention;

FIG. 3 illustrates a panel according to the third aspect of the invention;

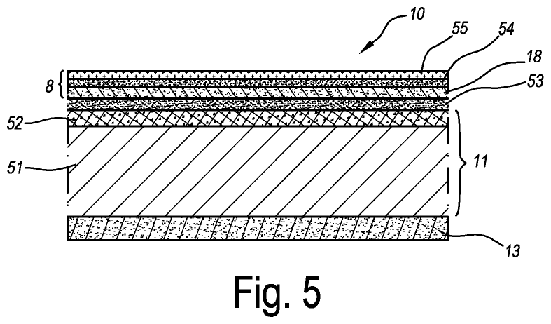

FIG. 4 illustrates a panel according to the third aspect of the invention; and

FIG. 5 illustrates a panel according to the sixth aspect and the seventh aspect of the invention.

FIG. 1 illustrates a panel (10) according to the second aspect of the invention. The panel (10) comprises a substrate (11) and a top layer (8). The top layer (8) comprises a decorative paper layer (18)—either of a uniform colour or printed with a decor. The decorative paper layer has been impregnated with melamine formaldehyde resin.

The top layer (8) comprises a wear layer (19) on top of the decorative paper layer (18). The wear layer is a melamine formaldehyde resin-impregnated paper layer which optionally comprises particles which increase the resistance to wear, for example aluminium oxide particles.

On the side facing the substrate (11), the top layer (8) comprises a layer of paper (16) impregnated with resin, preferably this resin is a phenol formaldehyde resin. In the example, this layer of paper (16) impregnated with resin is in direct contact with the decorative paper layer (18).

The top layer (8) is bonded to the substrate by means of a sheet (14), as in the first aspect of the invention. The sheet comprises a paper layer impregnated with polyurethane, in which the top layer (8) of the panel is bonded to the substrate by crosslinking the polyurethane of the sheet.

In the example from FIG. 1, the substrate (11) is a compact board, but it is not necessary for the invention that the substrate is or comprises a compact board. A compact board is a board which consists of sheets of paper which have been pressed together at elevated temperature and have been impregnated with a phenol formaldehyde resin.

The panel (10) comprises a backing layer (13) on the side opposite to the side which comprises the top layer (8). The backing layer (13) is a melamine formaldehyde resin-impregnated paper layer which is bonded to the substrate (11) by means of a sheet (12) as in the first aspect of the invention, in which the crosslinking of the polyurethane of this sheet provides the bond between the backing layer and the substrate. The sheet (13) comprises a paper layer impregnated with polyurethane.

Optionally, the decorative surface of the panel may contain a relief, for example because a textured pressure element has been used under pressure and at elevated temperature during the pressing operation. During this pressing operation, the various aforementioned layers are pressed together, causing crosslinking of the various resins and of the polyurethane.

FIG. 2 illustrates a panel (10) according to the second aspect of the invention. The panel (10) comprises a substrate (11) and a top layer (8). The top layer (8) comprises a decorative paper layer (18)—either uniform in colour or printed with a decor. The decorative paper layer was impregnated with melamine formaldehyde resin.

The top layer (8) comprises a wear layer (19) on top of the decorative paper layer (18). The wear layer is a melamine formaldehyde resin-impregnated paper layer which optionally comprises particles which increase the resistance to wear, for example aluminium oxide particles.

Although not shown in the example from FIG. 2, it is also possible for the side of the top layer facing the substrate to comprise a layer of paper impregnated with resin, preferably this resin is a phenol formaldehyde resin; this layer of paper impregnated with resin may be in direct contact with the decorative paper layer.

The top layer (8) is bonded to the substrate by means of a sheet (14) as in the first aspect of the invention. This sheet (14) comprises a paper layer impregnated with polyurethane, in which the top layer (8) of the panel is bonded to the substrate by crosslinking the polyurethane of the sheet.

In the example from FIG. 2, the substrate (11) comprises a compact board (17), but it is not necessary for the invention that the substrate comprises a compact board. A compact board is a board which consists of sheets of paper which have been pressed together at elevated temperature and have been impregnated with a phenol formaldehyde resin.

The substrate (11) comprises an additional layer on the side facing the top layer (8), in the example from FIG. 2, this additional layer is an aluminium foil (22). This aluminium foil (22) is bonded into the substrate by means of a sheet (20) as in the first aspect of the invention. This sheet (20) comprises a paper layer impregnated with polyurethane, in which the top layer (8) of the panel is bonded into the substrate by crosslinking the polyurethane of the sheet.

The panel (10) comprises a backing layer (13) on the side opposite the side which comprises the top layer (8). The backing layer (13) is a melamine formaldehyde resin-impregnated paper layer which is bonded to the substrate (11) by means of a sheet (12) as in the first aspect of the invention, in which the crosslinking of the polyurethane of this sheet provides the bond between the backing layer and the substrate. The sheet (13) comprises a paper layer impregnated with polyurethane.

Optionally, the decorative surface of the panel may contain a relief, for example because a textured pressure element has been used under pressure and at elevated temperature during the pressing operation. During this pressing operation, the various aforementioned layers are pressed together, causing crosslinking of the various resins and the polyurethane.

FIG. 3 illustrates a panel (10) according to the third aspect of the invention. The panel (10) comprises a substrate (11) and a top layer (8). The top layer (8) comprises a decorative paper layer (18)—either uniform in colour or printed with a decor. The decorative paper layer is impregnated with melamine formaldehyde resin.

The top layer (8) comprises a wear layer (19) on top of the decorative paper layer (18). The wear layer is a melamine formaldehyde resin-impregnated paper layer which optionally comprises particles which increase the resistance to wear, for example aluminium oxide particles.

On the side facing the substrate (11), the top layer (8) comprises a layer of paper (16) impregnated with resin, preferably this resin is a phenol formaldehyde resin. In the example, this layer of paper (16) impregnated with resin is in direct contact with the decorative paper layer (18).

The top layer (8) is bonded to the substrate by means of a polyurethane bonding layer (30). The polyurethane bonding layer (30) does not contain a carrier or a reinforcing layer.

This polyurethane bonding layer (30) may be produced by coating the layer of phenol formaldehyde resin-impregnated paper (16) with a polyurethane dispersion. The various layers—including the various layers of the top layer (8) as well—are then laminated to each other under pressure and temperature in a pressing process.

In the example from FIG. 3, the substrate (11) is a compact board, but it is not necessary for the invention that the substrate is or comprises a compact board. A compact board is a board which consists of sheets of paper which have been pressed together at elevated temperature and have been impregnated with a phenol formaldehyde resin.

The panel (10) comprises a backing layer (13) on the side opposite the side which comprises the top layer (8). The backing layer (13) is a melamine formaldehyde resin-impregnated paper layer which is bonded to the substrate (11) by means of a polyurethane bonding layer (31). This may be achieved by coating the melamine formaldehyde resin-impregnated paper layer which forms the backing layer with a polyurethane dispersion. During the pressing operation in which the panel is produced, crosslinking of the polyurethane occurs, producing the bond between the backing layer (13) and the substrate (11).

Optionally, the decorative surface of the panel may comprise a relief, for example because a textured pressure element has been used under pressure and at elevated temperature during the pressing operation. During this pressing operation, the various aforementioned layers are pressed together, causing crosslinking of the various resins and of the polyurethane.

FIG. 4 illustrates a panel (10) according to the third aspect of the invention. The panel (10) comprises a substrate (11) and a top layer (8). The top layer (8) comprises a decorative paper layer (18)—either uniform in colour or printed with a decor. The decorative paper layer was impregnated with melamine formaldehyde resin.

On top of the decorative paper layer (18), the top layer (8) comprises a wear layer (19). The wear layer is a melamine formaldehyde resin-impregnated paper layer which optionally comprises particles which increase the resistance to wear, for example aluminium oxide particles.

The top layer (8) is bonded to the substrate by means of a polyurethane bonding layer (30). The polyurethane bonding layer (30) does not contain a carrier or a reinforcing layer.

In the example from FIG. 4, the substrate (11) comprises a compact board (17), but it is not necessary for the invention that the substrate comprises a compact board. A compact board is a board which consists of sheets of paper which have been pressed together at elevated temperature and have been impregnated with a phenol formaldehyde resin.

On the side facing the top layer (8), the substrate (11) comprises an additional layer, in the example from FIG. 4, this additional layer is an aluminium foil (22). This aluminium foil (22) is bonded into the substrate by means of a polyurethane bonding layer (32). This may be achieved by coating the aluminium foil (22) with a polyurethane dispersion. The polyurethane bonding layer (30) by means of which the top layer (8) is bonded to the substrate may be achieved by also coating the other side of the aluminium foil (22) with a polyurethane dispersion.

In a pressing operation, the various layers are connected to each other under pressure and at elevated temperature by crosslinking the resins and the polyurethane.

The panel (10) comprises a backing layer (13) on the side opposite the side which comprises the top layer (8). The backing layer (13) is a melamine formaldehyde resin-impregnated paper layer which is bonded to the substrate (11) by means of a polyurethane bonding layer (31). This may be achieved by coating the melamine formaldehyde resin-impregnated paper layer which forms the backing layer with a polyurethane dispersion. During the pressing operation in which the panel is produced, crosslinking of the polyurethane occurs, producing the bond between the backing layer (13) and the substrate (11).

Optionally, the decorative surface of the panel may comprise a relief, for example because a textured pressure element has been used under pressure and at elevated temperature during the pressing operation. During this pressing operation, the various aforementioned layers are pressed together, causing crosslinking of the various resins and of the polyurethane.

FIG. 5 illustrates a panel (10) according to the sixth aspect and the seventh aspect of the invention. These two aspects are not necessarily combined in the invention.

The panel (10) from FIG. 5 comprises a substrate (11) and a top layer (8) bonded to the substrate (11). The top layer (8) comprises a decorative paper (18) impregnated with melamine formaldehyde resin or with acrylate resin. On the side bonded to the substrate (11), this decorative paper (18) comprises a polyurethane bonding layer (53) which provides the bond between the decorative paper and the substrate. Preferably, the polyurethane bonding layer (53) contains 7 to 15 grams per square metre of dry weight polyurethane.

The substrate (11) of the example from FIG. 5 comprises a first layer (51) and a second layer (52). In the example, the first layer is an MDF (Medium Density Fibreboard) or HDF (High Density Fibreboard). The second layer (52) is a layer which comprises polyvinyl butyral as a binder and a wood-based filler, for example wood chips and/or wood fibres.

The polyurethane bonding layer (53) provides the bond of the decorative paper layer (18) to the second layer (52) of the substrate (11).

On the other side than the side bonded to the substrate (11), the top layer (8) comprises a lacquer layer (55). This may be an acrylate lacquer layer, a polyurethane acrylate lacquer layer, a polyurethane lacquer layer or a thermosetting polyester lacquer layer. The lacquer layer (55) optionally comprises particles to increase the resistance to wear. A polyurethane bonding layer (54) provides the bond between the decorative paper (18) and the lacquer layer (55). This polyurethane bonding layer (54) preferably comprises 7 to 15 grams per square metre of dry weight polyurethane.

Optionally, the panel may comprise a backing layer (13), preferably a melamine formaldehyde resin-impregnated paper layer. This backing layer (13) may be bonded to the substrate by means of the melamine formaldehyde resin. Alternatively, the melamine formaldehyde resin-impregnated paper layer may be bonded to the substrate (11) by means of a polyurethane adhesion layer.

Optionally, the decorative surface of the panel may comprise a relief, for example because a textured pressure element has been used under pressure and at elevated temperature during the pressing operation. During this pressing operation, the various aforementioned layers are pressed together, causing crosslinking of the various resins and of the polyurethane

1.-54. (canceled)

55. A panel, in which the panel comprises a substrate and a top layer bonded to the substrate, in which the top layer contains a decorative paper, in which this decorative paper is impregnated with melamine formaldehyde resin or with acrylate resin, in which this decorative paper, on the side bonded to the substrate, comprises a polyurethane bonding layer which provides the bond between the decorative paper and the substrate.

56. The panel in accordance with claim 55, wherein the polyurethane bonding layer contains 7 to 15 grams per square meter of dry weight polyurethane.

57. The panel in accordance with claim 55, wherein by means of the polyurethane bonding layer, the decorative paper is bonded to a layer of the substrate which contains polyvinyl butyral as a binder on the one hand and a filler or a wood-based filler on the other hand.

58. The panel in accordance with claim 57, wherein the substrate also comprises a layer made of MDF (Medium Density Fibreboard) or HDF (High Density Fibreboard).

59. The panel in accordance with claim 55, wherein the polyurethane is anionically stabilized.

60. The panel in accordance with claim 55, wherein the polyurethane is self-crosslinking.

61. The panel in accordance with claim 55, wherein the polyurethane is at least partly carboxyl-stabilized.

62. The panel in accordance with claim 55, wherein the substrate comprises wood fibres or wood chips, wherein the wood fibres or the wood chips are glued together by means of a thermosetting adhesive or by means of a thermoplastic.

63. The panel in accordance with claim 55, wherein the decorative surface of the panel comprises a relief, wherein this relief has been pressed into the decorative surface.

64. The panel, wherein the panel comprises a substrate and a top layer bonded to the substrate, in which the top layer comprises a decorative paper, in which this decorative paper is impregnated with melamine formaldehyde resin or with acrylate resin, in which the top layer comprises a lacquer layer on the other side of the side bonded to the substrate, wherein the lacquer layer is selected from the list of an acrylate lacquer layer, a polyurethane acrylate lacquer layer, a polyurethane lacquer layer or a thermosetting polyester lacquer layer, wherein the panel comprises a polyurethane bonding layer which provides the bond between the decorative paper and the lacquer layer.

65. The panel in accordance with claim 64, wherein the polyurethane of the polyurethane bonding layer which provides the bond between the decorative paper and the lacquer layer is anionically stabilized.

66. The panel in accordance with claim 64, wherein the polyurethane of the polyurethane bonding layer which provides the bond between the decorative paper and the lacquer layer is self-crosslinking.

67. The panel in accordance with claim 64, wherein the polyurethane of the polyurethane bonding layer which provides the bond between the decorative paper and the lacquer layer is at least partly carboxyl-stabilized.

68. The panel in accordance with claim 64, wherein the substrate comprises wood fibres or wood chips, wherein the wood fibres or the wood chips are glued together by means of a thermosetting adhesive or by means of a thermoplastic.

69. The panel in accordance with claim 64, wherein the decorative surface of the panel comprises a relief, wherein this relief has been pressed into the decorative surface.

70. The panel as in claim 64, wherein the decorative paper is impregnated with melamine formaldehyde resin, wherein the melamine formaldehyde resin comprises at least 25% by weight of modifier with respect to the total amount of melamine formaldehyde resin.
